(19) United States
(12) Patent Application Publication
(10) Pub. No.: US 2012/0059293 A1
(43) Pub. Date: Mar. 8, 2012

(54) PERSONAL BACK AND BODY STIMULATOR

(76) Inventors: Gregory A. Collins, Las Vegas, NV (US); Don Shefler, Las Vegas, NV (US)

(21) Appl. No.: 12/876,399

(22) Filed: Sep. 7, 2010

(51) Int. Cl. A61H 23/00

(52) U.S. Cl. 601/46

(57) ABSTRACT

A back and body stimulator provides a variety of stimulation to body surfaces. The stimulator may comprise a frame that supports one or more stimulating elements. The frame may be held between two handles by one or more resilient or stretchable members. The stimulating elements may engage and be applied to a body surface via the handles. The user may stretch the resilient members to apply a force to the body surface. Stimulation may be provided by moving the stimulating elements across the body surface. The stimulating members may be mounted so as to rotate about distinct axis, to rotate irregularly, or both so that distinct sensations may be generated. The stimulator may include one or more vibration generators or vibrating elements.

### BACKGROUND OF THE INVENTION

1. Field of the Invention

The invention relates to devices for stimulating the soft tissues of the body, particularly to a personal back and body stimulator.

2. Related Art

A person's comfort and health can be improved by stimulation of the person's soft tissues, such as the muscles and skin. People often report that such stimulation is also a stress reliever. One form of stimulation of the soft tissues is a massage. Often this is performed by a masseuse and can be inconvenient and expensive. For instance, a massage typically requires an appointment and is charged in hour or smaller time increments.

Personal massagers exist as well. For example, handheld massagers that serve as an extension to a user's hand have been produced. In general, a person would apply a personal massager to him or herself as desired. Though these traditional massagers provide a massage, this type of stimulation may not be well suited to those seeking stimulation of the soft tissues of the back or other area of the body.

From the discussion that follows, it will become apparent that the present invention addresses the deficiencies associated with the prior art while providing numerous additional advantages and benefits not contemplated or possible with prior art constructions.

### SUMMARY OF THE INVENTION

A back and body stimulator is disclosed herein. The back and body stimulator allows a user to stimulate his or her own body surfaces easily and conveniently. In addition the stimulator provides a wide variety of sensations through its stimulating elements and associated elements and the sensations provided are easily adjustable and controllable by the user. The stimulator is also highly customizable.

The back and body stimulator may have various configurations. For example, in one embodiment, the back and body stimulator may comprise one or more stimulating elements configured to provide at least one sensation to a user through contact with the user, and a frame having a first end and a second end and comprising one or more voids. At least one of the one or more stimulating elements may include a vibration generator powered by a power source.

The frame may comprise a planer body having one or more flat planar sections adjacent the voids. Alternatively or in addition, the frame may comprise a plurality of elongated elements extending between the first handle and the second handle. It is noted that the frame may comprise one or more rows for holding stimulating elements. The rows may have at least one coupling edge to connect and disconnect from one another.

The voids may be configured to accept the stimulating elements therein. The voids may be positioned between a first edge and a second edge of the frame such that the frame surrounds the voids. Alternatively or in addition, the voids may be positioned at an edge of the frame such that the voids form one or more openings at the edge of the frame.

One or more mounts may be at the one or more voids. The mounts may be configured to secure the one or more stimulating elements within the voids by engaging a portion of the one or more stimulating elements. It is noted that at least one of the mounts may be oriented at a diagonal relative to another of the mounts.

At least two resilient members configured to resiliently stretch and contract may be included. A first of the resilient members may extend between the first end of the frame and a first handle, while a second of the resilient members may extend between a second end of the frame and a second handle. The frame may comprise a vibration generator powered by a power source.

In another exemplary embodiment, a back and body stimulator may comprise one or more resilient members configured to resiliently stretch and contract. The resilient members may have a first end and a second end and be attached to a handle at their first end. The resilient members may be attached to a frame having a plurality of voids therein at their second end.

A plurality of stimulating elements comprising a textured surface and one or more openings may be provided. The stimulating elements may be configured to provide at least one sensation to a user through contact with the user. One or more mounts may be at the plurality of voids. The mounts may be mounted at a plurality of distinct angles and may be configured to engage the openings of the stimulating elements to secure the plurality of stimulating elements at the plurality of voids.

It is noted that at least one of the stimulating elements may have a first textured surface while at least another of the stimulating elements has a second textured surface (with the second textured surface being distinct from the first textured surface). The openings of the stimulating elements may have a polygonal peripheral shape to cause the stimulating elements to roll in an irregular manner thus providing a unique sensation/stimulation to the user.

Various methods of body surface stimulation are also disclosed herein. For example, in one embodiment a method of stimulating body surfaces is disclosed. The method may comprise grasping a first handle with a first hand, grasping a second handle with a second hand, and engaging a body surface with one or more stimulating elements rotatably supported by a frame secured between the first handle and the second handle. The body surface may be engaged by positioning the first handle and to the second handle adjacent opposite sides of body surface.

One or more resilient members connecting the first handle to the frame may be stretched to increase the force applied to the body surface through the one or more stimulating elements. One or more additional resilient members connecting the second handle to the frame may be stretched as well.

At least one of the stimulating elements may be rolled across the body surface at a first axis by moving at least the first handle. At least another of the stimulating elements may be rolled across the body surface at a second axis that is distinct from the first axis. Rolling the at least one of the stimulating elements across the body may comprise rolling at least one of the stimulating elements in an irregular manner about a non-circular opening in the at least one of the stimulating elements.

At least one of the resilient members may be disconnected from the frame and the first handle. One or more replacement resilient members may then be connected to the frame and the first handle. The replacement resilient members may be more or less difficult to stretch than the removed resilient member(s) to provide a different sensation or force to the user. It is noted that a coupling edge between two rows of the frame may be disengaged to remove a row of the stimulating elements.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates a front view of an exemplary back and body stimulator;

FIG. 2A illustrates a first exemplary frame of a back and body stimulator;

FIG. 2B illustrates a second exemplary frame of a back and body stimulator;

FIG. 2C illustrates a third exemplary frame of a back and body stimulator;

FIG. 3 illustrates exemplary stimulating elements for use with a back and to body stimulator; and

FIG. 4 illustrates an exemplary use of a back and body stimulator.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the personal back and body stimulator provides physical stimulation for the soft tissues of a user's back and body. Typically, the back and body stimulator will be used to stimulate the soft tissues of the user's back, however, as its name implies, the stimulator may be used for a variety of other body structures and areas.

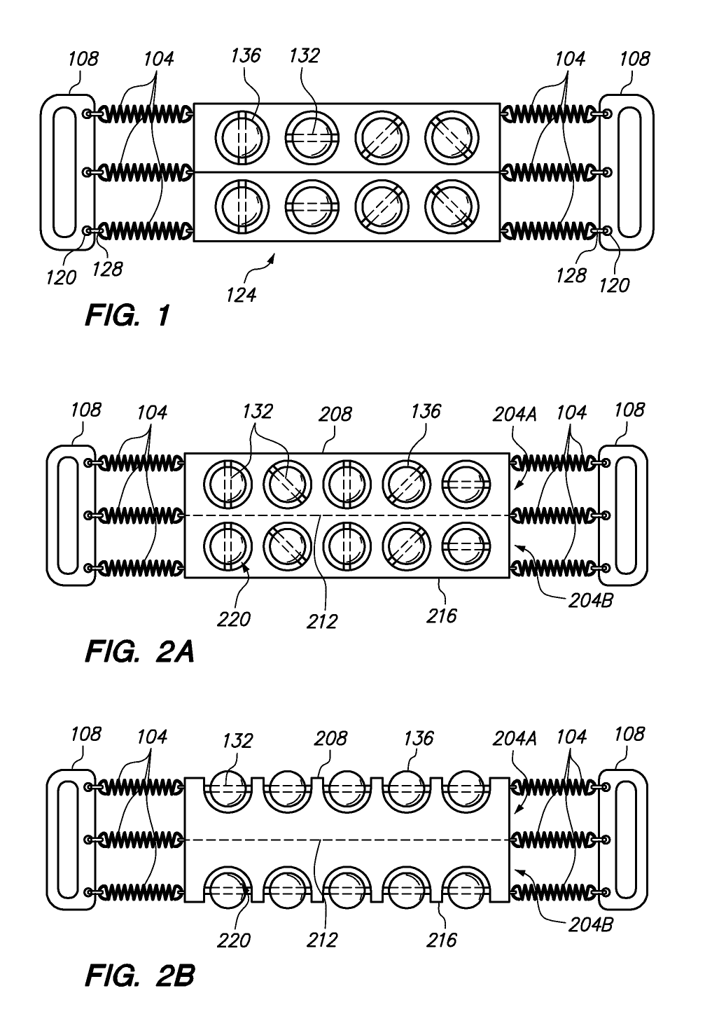

The stimulator will now be described with regard to the figures. FIG. 1 illustrates a resilient support assembly for the stimulator. In general, the support assembly holds one or more stimulating elements so that they may be applied to a user's soft tissues, such as in the back or other portion of the body.

The support assembly may comprise various elements. For example, the support assembly may comprise a frame 124 configured to support one or more stimulating elements 136. For example, the frame 124 may comprise one or more mounts 132 which hold the stimulating elements 136 to the frame. As shown in FIG. 1 for example, the stimulating elements 136 are secured to the frame by mounts 132 comprising elongated members which extend through an opening in each of the stimulating elements 136. As can be seen, a number of stimulating elements 136 may be secured to the frame 124. In this manner, a user may apply multiple stimulating elements 136 to his or her back or body simultaneously.

The frame 124 may be attached to one or more handles 108, such as the two handles shown in FIG. 1. The frame 124 may be held between the handles 108 in one or more embodiments. In this manner, a user may hold both ends of the stimulator by grasping a first handle 108 in one hand and a second handle in the other hand. The handles 108 may be configured to be easily held by a user. For example, the handles 108 may have portions which the user may wrap his or her fingers around. In this way, the user may securely grasp the stimulator during use.

The connection between the frame 124 and the handles 108 may be made directly (such as by directly attaching the support members to the handles) or indirectly. In addition, the handles 108 and the frame 124 may be rigidly or flexibly attached. In a rigid embodiment, an inflexible connector may be used to connect the frame 124 and handles 108. For example, the frame 124 may be connected by one or more metal or other rigid fasteners, such as screws, pins, clips, clamps, hooks, loops, and the like. Various other fasteners may be used as well.

In elastic embodiments, a resilient or flexible attachment may be used. For example, the frame 124 may be attached to the handles 108 via one or more resilient members 104, such as the springs shown in FIG. 1. It is noted that the resilient members 104 may be elastic bands or other elastic structures in some embodiments. It is also noted that each handle 108 need not be attached in the same way. For example, one handle 108 may be rigidly attached while another handle is attached by a resilient member 104.

One or more resilient members 104 may be used to attach a handle 108 to the frame 124. As shown in FIG. 1 for example, three resilient members 104 are used to attach a handle 108. Increased numbers of resilient members 104 may increase the amount of resistance to stretching provided by the resilient members 104. In addition, additional resilient members 104 may help stabilize the frame 124 relative to the handles 108. For example, two or more resilient members 104 may be attached to a handle 108 near the handle's sides or ends to prevent the handle from rotating or twisting relative to the frame 124.

In use, the resilient members 104 are highly beneficial in that they help apply the frame 124 (and thus the stimulating elements 136 held by the frame) to the user's body. The resilient members 104, when stretched, provide a force which applies the frame 124 to the user's body. In this manner, the user need not hold the stimulator specifically to apply its frame to the user's body. Instead, the user is free to hold the stimulator in various positions. As long as the resilient members 104 are stretched, they will help ensure that a force is being applied to the user's body via the frame 124. This permits an increased range of motion and increased convenience for the user when applying the stimulator to his or her body. In addition, the user may experience some muscle toning or training as a result of stretching the resilient members 104 as the stimulator is used.

Moreover, the resilient members 104 allow the stimulator to have a variable length. For instance, as the resilient members 104 stretch, the stimulator may be elongated. As the resilient members 104 contract, the stimulator's length may be reduced. This adjustability or stretchability allows the stimulator to be easily used for various areas of the body. For example, a stimulator of fixed length may not be sufficiently sized to reach around a user's torso (or other body area). In such case, the user would be limited as far as where he or she may apply the stimulator. In contrast, the resilient members 104 allow the stimulator to stretch, in turn allowing its handles 108 to be held further from the frame 124. In this manner, the stimulator may reach around a user's torso (or other body area).

In addition, the ability of the stimulator to stretch allows the stimulator to be used by a user in various positions. For example, the additional length created by stretching the resilient members 104 may allow a user to apply the stimulator to the bottom of his or her feet without having to bend at the knees.

The resilient members 104 also allow the stimulator to be applied to the body with a more consistent force. This is because the resilient members 104 provide some force themselves. Thus, the amount of force applied to a user's body via the frame 124 does not directly correspond to the amount of force the user is applying at the stimulator's handles 108. For example, if a user inadvertently reduces the amount of force applied to the handles 108, that reduction would be felt at the frame 124. With the resilient members 104 force may be provided partially by the resilient members, as stated. In this way, a reduction in force applied at the handles 108 may not be perceivable at the frame 124.

The handles 108 may be configured to engage one or more resilient members 104 to allow attachment thereto. For instance, in FIG. 1, the handles 108 comprise mounts 120 in the form of openings which accept a loop-type connector 128 that fastens a resilient member 104 to a handle 108. Various other connectors 128 may be used, including those described above.

It is noted that, though not shown, in some circumstances or as desired, a user may wrap some or all the stimulating elements 136 in a wrapping. Typically such wrapping will have its own stimulating texture that provides a sensation when moved across a body surface. The wrapping may be flexible so as to allow it to wrap around at least a portion of the frame and at least some of the stimulating elements 136. The wrapping may have a planar structure in some embodiments. It is contemplated that the wrapping may have two sides or ends which, when wrapped around the frame 124, may releasably connect (e.g., connect by zipper, buttons, hook and loop fastener, or other releasable connector) to secure the wrapping to the frame. Alternatively, the wrapping may be a loop or the like which may be placed around the frame and one or more stimulating elements 136. The wrapping may have various textures on at least one side. For example, the wrapping may have a rough, smooth, irregular, or other texture. In one embodiment, the wrapping may have a texture comprising one or more flexible elongated members of thin or thick diameter that extend from the surface of the wrapping.

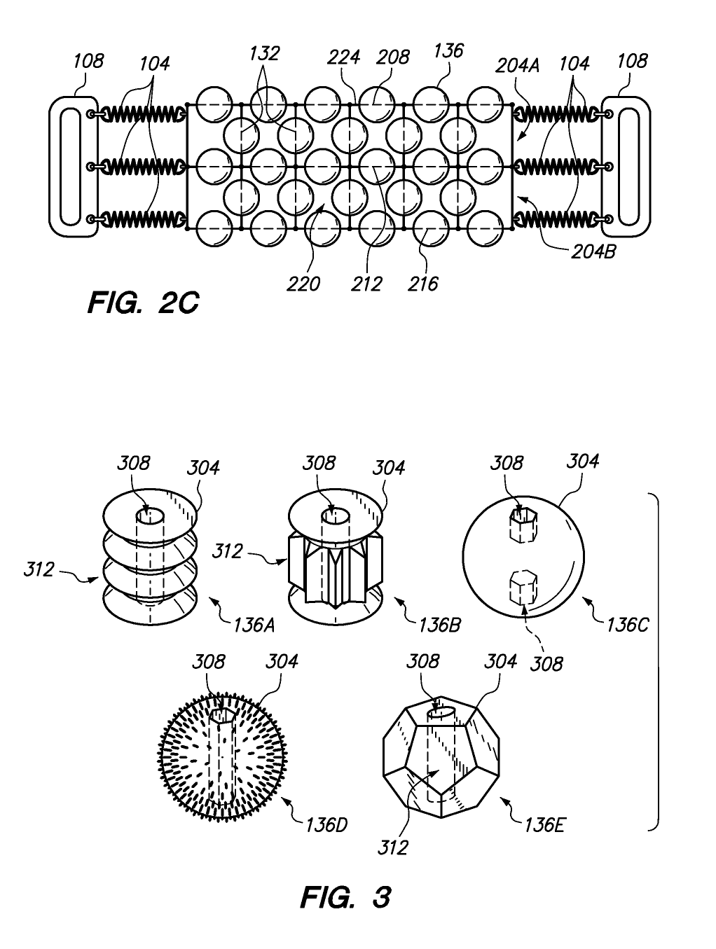

The frame will now be discussed in further detail with regard to FIGS. 2A-2C. The frame 124 may have a variety of shapes, sizes, and elements to allow the frame to hold one or more stimulating elements 136, such as shown in FIGS. 2A-2C. The frame 124 or sections thereof may be formed from one or more materials. These materials may be rigid, semi-rigid, or flexible. For example, the frame 124 may comprise wood, metal, plastic, rubber, chain or rope, and/or fabric in one or more embodiments. Portions of the frame 124 may be rigid while other portions may be flexible. This permits the frame 124 to conform to the shape of a user's body while applying a force to the user's body. Alternatively, the frame 124 may be completely rigid or completely flexible to suit the needs of particular users. Generally speaking, a rigid frame 124 applies more force to a user's body while a flexible frame may conform better to the shape of a user's body to stimulate more areas of the body.

The frame 124 may hold stimulating elements 136 in various arrangements. For example, in FIG. 2A, the frame 124 holds “rows” of stimulating elements 136 in a first row 204A and a second row 204B.

The rows 204A,204B have been delineated by a dashed line 212 for reference purposes. It is contemplated that an actual line, channel, or the like may be used in one or more embodiments. It is also contemplated that the frame 124 may have separate sections or rows in one or more embodiments. For example, rather than being connected at the dashed line, the rows 204A,204B may be separate and independent structures. This is advantageous in that the independent rows 204A,204B may bend or move relative to one another allowing the frame 124 to follow a variety of surfaces, such as various curves of a user's body.

Each row may be delineated by one or more edges. For example, in FIG. 2A, the first row 204A may have a first edge 212 and a second edge 208, and the second row 204B may similarly have a first edge 212 and a second edge 216.

Referring to FIG. 2A, it can be seen that a frame 124 may comprise one or more voids 220 or open sections which accept at least a portion of a stimulating element 136. It is contemplated that a single void 220 may accept a plurality of stimulating elements 136 in some embodiments. For example, relative to FIG. 2A, a void 220 may be enlarged to accept multiple stimulating elements 136, multiple stimulating elements 136 may have a reduced size to fit into a single void, or both. The voids 220 may be between the edges 212,208 of a row or section of the frame 124 in one or more embodiments.

As discussed, the frame 124 may comprise elements, such as mounts 132, which secure or hold one or more stimulating elements 124. Typically, these elements will hold a stimulating element 124 within a void 220. As shown in FIG. 2A, the mounts 132 comprise elongated members which pass through an opening in the stimulating elements 136. In this manner, the mounts 132 hold the stimulating elements 136. In addition, the stimulating elements 136 may rotate about the mounts, which enhances the stimulation provided by the back and body stimulator. This is especially so when the stimulating elements 136 are textured, as will be described further below.

The mounts 132 may extend from an interior surface of a void 220. In this manner, the mounts 132 may hold a stimulating element 136 within the void 220. It is noted that the mounts 132 may extend partially into (such as shown in FIG. 2B) or through a stimulating element (such as shown in FIG. 2A). In addition, the mounts 132, frame 124, and/or stimulating elements 136 may be configured to permit the stimulating elements to be removed and replaced, individually or in groups.

For example, the mounts 132 may be spring loaded elongated members having an adjustable length. This allows the length of the elongated members to be reduced, such as to remove the elongated members. Once removed, a stimulating element 136 held by the elongated member may be removed from the elongated member and replaced with another stimulating member. The replacement may have different characteristics, such as a different shape or texture, to provide different stimulation to the user's body. The elongated member may then be secured to the frame 124, with an internal spring forcing the ends of the elongated member into/against a portion of the frame, such as an inner surface of a void 220.

The mounts 132 may be made removable in a variety of other ways. For example, mounts 132 may be held in place by one or more friction or snap fitting connectors or structures at the periphery of a void 220. In this manner, mounts 132 having one or more stimulating elements 136 thereon may be pressed into the snap fit connector(s) to secure the stimulating elements, and pulled out of the connector(s) to remove the stimulating elements.

The mounts 132 may be threaded in some embodiments and may be held in place by threaded holes at the periphery of a void 220. In embodiments where a stimulating element 136 would block access to a threaded mount 132 (making it impossible or difficult to turn the mount), it is contemplated that the stimulating element 136 may temporarily engage the threaded mount 132 such that turning the stimulating element also turns the treaded mount. In this manner, the threaded mount 132 may be removed or attached by turning the stimulating element 136. It is contemplated that a retractable detent may extend from a stimulating element 136 to an indentation (or similar) on the mount 132 to temporarily engage the mount such that the mount and stimulating element turn together.

In other embodiments, the mounts 132 may be held in place by one or more removable fasteners. For example, one or more pins or screws could pass through a portion of the frame 124 and into the mounts 132 to secure the mounts relative to the frame. The fasteners may be removed to release the mounts 132 allowing stimulating elements 136 to be removed or replaced.

It is contemplated that sets or groups of stimulating elements 136 may removable or replaceable in one or more embodiments. This may be accomplished in a variety of ways. For example, a user may replace the entire frame 124 with another frame having one or more distinct stimulating elements 136. This may occur by disconnecting the frame 124 from the resilient members 104 and attaching a different frame. Alternatively, the frame 124 and resilient members 104 may be disconnected from the handles 108 and a different frame and resilient members reconnected. As discussed above, these connections may be made by connectors such as clips, clamps, loops, and the like. The connectors may be configured to “open” or be removed to allow resilient members 104, the frame, the handles 108, or combinations thereof to be connected and disconnected.

Sets of stimulating elements 136 may also be made removable or replaceable in sections. For example, sections, such as rows 204A,204B of the frame 124 may be independently removed and replaced. In one embodiment, a row 204A may be removed by disconnecting the row from the resilient members 104 supporting the row. Another row, such as one having one or more different stimulating elements 136, may then be connected in place of the removed row.

It is contemplated that each row 204A,204B may connect to one another in some embodiments. For example, in FIG. 2A, the rows 204A,204B may be connected at an edge 212. This allows the rows 204A,204B to bend or move together when desired. Such connection may be accomplished in various ways. For example, a zipper or the like may form the connection. Alternatively or in addition, one or more or a strip of hook and loop fasteners may be used to form the connection. It is also contemplated that the edge 212 of the rows 204A,204B may be shaped to interlock with one another, such as in embodiments where the rows 204A,204B are formed from rigid or semi-rigid materials. For example, an edge of a first row 204A may be a channel while an edge of a second row 204B may be a matching groove (e.g., a groove having a similar cross sectional shape). As stated above however, the rows 204A,204B or other sections of a frame 104 may be configured to remain independent and separate, if desired.

Referring now to FIGS. 2B-2C, it can be seen that the frame 124 and void(s) 220 therein may have a variety of configurations. For instance, in FIG. 2B, the voids 220 extend to the edge 208 of the frame 124. In this manner, a stimulating element 136 may be attached and removed at the edge 208 of the frame 124. In addition, this configuration causes the rows 204A,204B of the frame 124 to have an inverted scalloped shape, with each void 220 capable of accepting one or more stimulating elements 136.

FIG. 2B also shows a configuration of the mounts 132 that extends into but not all the way through a stimulating element 136. As can be seen, the mounts 132 extend a reduced amount from the interior surface of the voids 220. It is contemplated that these mounts 132 may be moved to insert and remove a stimulating element 136. For example, a user may widen the void 220 at the mounts 132 and position a stimulating element 136 therein while aligning openings or indentations in the stimulating element with the mounts. The void 220 and mounts 132 may then be allowed to return to their original state. In this state, the mounts 132 may be within the openings or indentations of the stimulating element 136, holding the element in place.

Alternatively or in addition, the mounts 132 may be spring loaded and extend/retract from the interior surface of a void. In this manner, the mounts 132 may be retracted or “pushed in” to remove or insert a stimulating element 136. The mounts 132 may then extend into the stimulating element 136 to secure the element in place. It is contemplated that various mounts 132 may be used with various configurations of voids 220. For example, the mounts 132 described above with regard to FIG. 2A (or of another embodiment of the back and body stimulator) may be used with the rows 204A,204B or frame 124 of FIG. 2B (or another embodiment of the stimulator).

In FIGS. 2A-2B, the frame 124 or sections thereof may have a planar or sheet-like configuration. In general, the thickness of the frame 124 will be less than that of the stimulating elements 136. In this way, the sitmulating elements 136 may extend outward beyond the surface of the frame 124. This allows the stimulating elements 136 to contact the user's body.

Referring now to FIG. 2C, it can be seen that the frame 124 or sections thereof may be formed from elongated members as well. In FIG. 2C for example, the frame 124 comprises elongated members 224 extending in a direction from one handle of the stimulator to another. In some embodiments, the elongated members 224 may be at the edges 208,212,216 of its rows 204A,204B. Mounts 132 may extend between these elongated members 224 to hold one or more stimulating elements 136 to the frame 124. It is noted that the elongated members 224 may themselves hold one or more stimulating elements 136. It is noted that while shown in FIG. 2A as having stimulating elements 136 on both the elongated members 224 and mounts 132, the stimulator may only have stimulating elements 136 on its mounts or elongated members 224 but not both. In addition, it is noted that stimulating elements 136 need not be on every mount 132 or on every segment of an elongated member 224. The stimulating elements 136 may be placed as desired to achieve the desired user experience.

As described above, the frame 124 may be rigid or flexible and constructed from various materials. Accordingly, the elongated members 224 may be rigid or flexible. In addition the elongated members 224 may be made from various material(s). For example, the elongated members 224 may be plastic, rubber, metal wire, natural or synthetic fibers, and the like. The frame 124 may be made flexible in other ways as well. For example, one or more flexible or pivoting joints may be used to connect portions of the frame 124. The joints may be configured to bend or flex in one or multiple directions. Portions of the frame 124 between the joints may be rigid or semi-rigid, in one or more embodiments. Referring to FIG. 2C, it is contemplated that a pivoting or flexible joint may be at one or more of the junctions where the elongated members 224 and mounts 132 meet.

In some embodiments, the elongated members 224 may have a diameter which allows the members to fit into an opening of a stimulating element 136 to permit the elongated members to hold stimulating elements thereon. It is contemplated that the elongated members 224, mounts 132, or both may have various cross sectional shapes. For example, the elongated members 224, mounts 132, or both may have a non-circular shape, such as an oval, square, rectangle, or various curved or polygonal shapes. A stimulating element 136 may have a matching or similarly shaped opening that engages the cross sectional shape. In this manner, the stimulating element 136 may be prevented from rolling about the elongated member 224 or mount 132. In this way, the stimulating element 136 may slide rather than roll across a user's body, providing a different sensation depending on the texture, shape, or other configuration of the stimulating element.

It is noted that the stimulating elements 136 need not have matching openings. For example, the stimulating element 136 may have an opening of a first shape while the elongated member 224 or mount 132 has a second distinct cross sectional shape. The opening may be larger than the diameter of the elongated member 224 or mount 132 to allow the stimulating element 136 to move laterally about the elongated member or mount. In this manner, the stimulating element 136 may “roll” about the elongated member 224 or mount 132 in a unique pattern, thus providing a unique sensation to the user. For example, a stimulating element 136 having a hexagonal opening would rotate about a circular elongated member 224 or mount 132 in an irregular manner, thus providing a unique sensation to the user when applied to the user's body.

Some exemplary stimulating elements will now be described with regard to FIG. 3. In general, a stimulating element 136 comprises a body 304 that can be applied to a user to generate a sensation once it is in contact with the user. The body 304 may have a surface or texture 312 which generates a particular sensation when in contact with the user. For example, stimulating element 136A has a cylindrical shape including texture 316 having a plurality of ridges. The ridges may be in a continuous “corkscrew” type configuration such that a single ridge continues along the height of the stimulating element 136A. Alternatively, there may be individual ridges which surround the body 304 of the stimulating element 136A.

Stimulating element 136B illustrates another exemplary texture 312 comprising a set of ridges. Stimulating element 136C illustrates a smooth texture 312, while stimulating element 136D illustrates a jagged texture having protrusions which extend radially outward from the stimulating element.

The body 304 of a stimulating element may have various shapes to which a texture may be applied. For example, stimulating element 136A and stimulating element 136B have a cylindrical shape, while stimulating element 136C and stimulating element 136D have spherical shapes. Stimulating element 136E illustrates a spherical polygonal shape. It is contemplated that other shapes may be used. For example, the body 304 of a stimulating element may be a square, rectangular, oval, polygonal, curved, or other shape.

The body 304 of a stimulating element may have an opening 308 that may be used to engage one or more mounts (as described above) to hold the stimulating element in place. The opening 308 may extend through the stimulating element 136A. For example, the opening 308 may extend from a first end of the stimulating element 136A to a second end, such as illustrated in stimulating element 136A. In this manner, a mount may extend through the stimulating element 136A. Alternatively, more than one mount may extend into the stimulating element 136A. For example, a first mount may extend into the opening at one end of the stimulating element, while another mount extends into the opening at the other end of the stimulating element.

As can be seen, the stimulating element 136A may “roll” about a mount that has been inserted into the stimulating element's opening. In this manner, the texture 312 may be applied to the user. It is contemplated that the texture 312 may be positioned or configured based on the direction or axis in which the stimulating element 136A rolls. For example, the ridges of stimulating element 136A run substantially perpendicular to the direction in which the stimulating element rolls (as can be seen from the position of the opening 308 extending through the stimulating element). This allows the ridges to have continuous contact with the user when applied. In an alternative embodiment, a stimulating element could have ridges that run perpendicular to the rotation of the stimulating element, such as illustrated by stimulating element 136B. In this manner, the ridges or texture 312 have temporary contact with the user when the stimulating element 136B is applied or rolled along a portion of the user's body.

It is contemplated that multiple openings 308 may be provided, such as shown by stimulating element 136C. Each opening 308 may accept a mount to hold the stimulating element 136C in place. The openings 308 may be aligned linearly such as shown, or may be in a non-aligned position such as to cause the stimulating element 136C to roll in an irregular or non-circular manner to provide a unique sensation to the user.

As discussed, the openings 308 may have various shapes. For example, stimulating element 136C and stimulating element 136D illustrate openings 308 have a polygonal shape. Stimulating element 136E illustrate an oval shaped opening 308, and stimulating element 136A and stimulating element 136B illustrate a circular shaped opening 308.

It is contemplated that one or more stimulating elements may vibrate in one or more embodiments. For example, a stimulating element may have a vibration generator or mechanism, which when activated, causes the stimulating element to vibrate. The vibration generator may be driven by a motor in one or more embodiments and be powered by an electrical or other power source. The power source and motor may be stored in an internal compartment of a stimulating element. Alternatively, the power source may be remotely stored and connected to the stimulating elements via one or more electrical conductors. For example, one or more batteries could be stored in the handles of the stimulator rather than in the stimulating elements themselves. The larger size of the handles allow larger capacity batteries to be used. It is contemplated that the stimulating elements may be powered by a external source, such as a wall outlet, in one or more embodiments.

Vibration provides an added sensation on top of the shape and texture provided by a stimulating element. This is beneficial in that it provides additional stimulation. In one or more embodiments, the vibration may be activated and deactivated by one or more switches or the like. Vibration may be activated and deactivated on stimulating elements individually or on a set of stimulating elements. For example, each stimulating element may have a switch or a single switch may be connected to multiple stimulating elements. In addition, the user may attach various combinations of vibrating and non-vibrating stimulating elements to the frame in one or more embodiments.

In one or more embodiments, individual stimulating elements may activate and deactivate randomly or at particular interval(s) to provide an irregular vibrating sensation across the frame of the stimulator. For example, each stimulating element may include a timer or controller which activates vibration periodically or at random times for a particular period of time or for a period of time of random duration. Alternatively, a timer or controller may be shared among multiple stimulating elements. The timer or controller may then randomly or periodically control vibration of the stimulating elements, together or individually.

It is contemplated that stimulating elements may be activated based on their location on the frame. For instance, stimulating elements in a particular row, column, or other area of the frame may be activated at the same time while other stimulating elements are activated at other times. In addition, stimulating elements may be activated in a particular sequence based on their location. For example, vibration may be activate for individual stimulating elements from left to right or top to bottom on a frame or vice versa. Vibration may also be randomly activated for stimulating elements as well. For example, in one embodiment, the controller may randomly choose a stimulating element to activate.

It is noted that other portions of the stimulator may vibrate in some embodiments. For example, the handles and/or frame of the stimulator may vibrate in addition to or instead of the stimulating elements. One or more vibration generators may be mounted on or in the handles and/or frame to provide a vibrating sensation to the user.

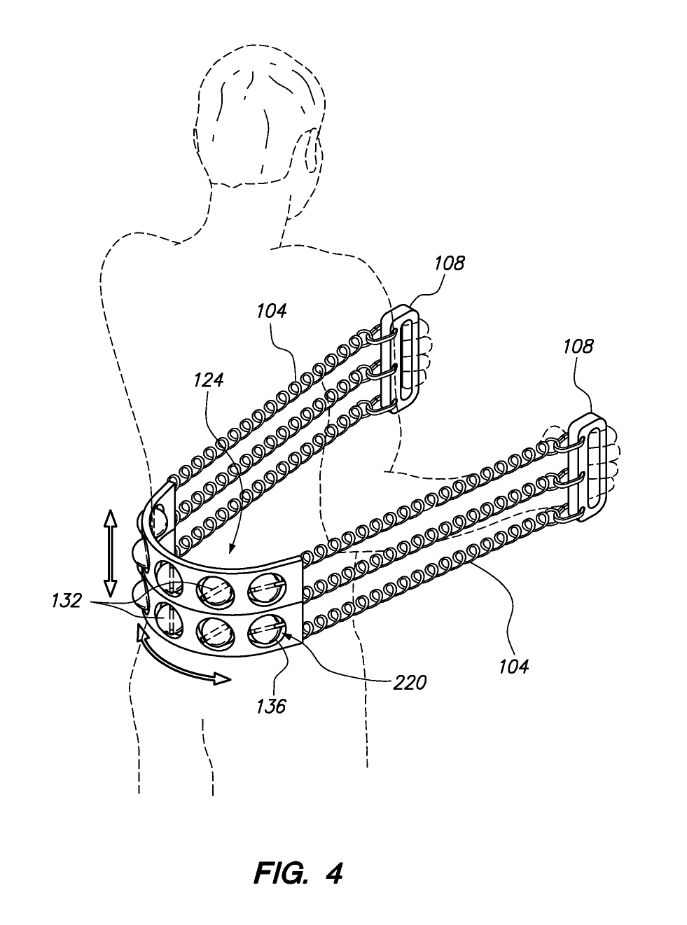

FIG. 4 illustrates the back and body stimulator in use. As illustrated the user is applying the stimulator to his back. As discussed above, the stimulator may be applied to various areas of the body, such as the arms, legs, neck, buttocks, and torso. The user may grasp or hold the handles 208 of the stimulator to apply pressure to his or her body via the frame 124. Since the frame 124 holds one or more stimulating elements 136, the stimulating elements are applied to the user's body in this manner.

The user may stretch one or more resilient members 104 as he or she applies the stimulator to his or her body. This may provide additional force and helps the frame 124 and stimulating elements 136 conform to the portion of the user's body to which the stimulator is being applied. In addition, the force provided by stretching the resilient members 104 make it easier for the user to keep the stimulating elements 136 in contact with his or her body, even while moving.

As shown by the arrows, the user may move the frame 124 and stimulating elements 136 horizontally, vertically, or both. The user may move the frame 124 and stimulating elements 136 to the left or to the right as desired by moving his or her arms accordingly. Likewise, the user may move the frame 124 and stimulating elements 136 up and down, such as by raising and lowering his or her arms. The user may repeat one or more movements or combinations of movements until the desired stimulation is achieved.

One or more of the stimulating elements 136 may be mounted such that they roll in a particular direction. For example, as shown, some of the stimulating elements 136 are mounted on horizontal mounts 136 and thus roll in a vertical direction. Other stimulating elements 136 are mounted on vertical mounts 136 and thus roll in a horizontal direction. Thus, the user experiences a rolling sensation from some of the stimulating elements 136 and a sliding or stroking sensation from other stimulating elements depending on how the frame 124 and stimulating elements are moved (e.g., horizontally or vertically). It is noted that the stimulating elements 136 may both roll and slide at the same time, such as when moved in a particular direction. For example, in FIG. 4, one or more stimulating elements 136 may roll and slide when the frame 124 is moved diagonally along the user's back.

The user may secure various stimulating elements 136 to the frame 124 based on how the user intends to apply the stimulator to his or her body. For example, the stimulating elements having a smooth texture may be secured to horizontal mounts 132 while, stimulating elements with an irregular or raised texture may be secured to vertical mounts. In this manner, when the frame is moved horizontally (i.e., left to right and vice versa), the smooth stimulating elements 136 slide along the user's body while the textured elements roll along the user's body, providing unique sensations.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A back and body stimulator comprising:
one or more stimulating elements configured to provide at least one sensation to a user through contact with the user;
a frame having a first end and a second end and comprising one or more voids, the one or more voids configured to accept the one or more stimulating elements therein;
one or more mounts at the one or more voids, the one or more mounts to configured to secure the one or more stimulating elements within the one or more voids by engaging a portion of the one or more stimulating elements; and
at least two resilient members configured to resiliently stretch and contract, a first of the resilient members extending between the first end of the frame and a first handle, and a second of the resilient members extending between a second end of the frame and a second handle.

2. The back and body stimulator of claim 1, wherein at least one of the one or more mounts is oriented at a diagonal relative to another of the one or more mounts.

3. The back and body stimulator of claim 1, wherein the one or more voids are positioned between a first edge and a second edge of the frame such that the frame surrounds the one or more voids.

4. The back and body stimulator of claim 1, wherein the voids are positioned at an edge of the frame such that the one or more voids form one or more openings at the edge of the frame.

5. The back and body stimulator of claim 1, wherein the frame comprises one or more rows for holding the plurality of stimulating elements, the one or more rows having at least one coupling edge to connect and disconnect from one another.

6. The back and body stimulator of claim 1, wherein the frame comprises a to planer body having one or more flat planar sections adjacent the one or more voids.

7. The back and body stimulator of claim 1, wherein the frame comprises a plurality of elongated elements extending between the first handle and the second handle.

8. The back and body stimulator of claim 1, wherein at least one of the one or more stimulating elements comprises a vibration generator powered by a power source.

9. A back and body stimulator comprising:
one or more resilient members configured to resiliently stretch and contract, the one or more resilient members having a first end and a second end and attached to a handle at their first end;
a frame having a plurality of voids therein, the one or more resilient members attached to the frame at their second end;
a plurality of stimulating elements comprising a textured surface and one or more openings, the stimulating elements configured to provide at least one sensation to a user through contact with the user;
one or more mounts at the plurality of voids, the one or more mounts mounted at a plurality of distinct angles and configured to engage the one or more openings to secure the plurality of stimulating elements at the plurality of voids.

10. The back and body stimulator of claim 9, wherein at least one of the plurality of stimulating elements has a first textured surface and at least another of the plurality of stimulating elements has a second textured surface, the second textured surface distinct from the first textured surface.

11. The back and body stimulator of claim 9, wherein the one or more openings of the plurality of stimulating elements have a polygonal peripheral shape.

12. The back and body stimulator of claim 9, wherein at least one of the one or more stimulating elements comprises a vibration generator powered by a power source.

13. The back and body stimulator of claim 9, wherein the frame comprises one or more rows for holding the plurality of stimulating elements, the one or more rows having at least one coupling edge to connect and disconnect from one another.

14. The back and body stimulator of claim 9, wherein the frame comprises a vibration generator powered by a power source.

15. A method of stimulating body surfaces comprising:
grasping a first handle with a first hand;
grasping a second handle with a second hand;
engaging a body surface with one or more stimulating elements rotatably supported by a frame secured between the first handle and the second handle, wherein the body surface is engaged by positioning the first handle and the second handle adjacent opposite sides of body surface;
stretching one or more resilient members connecting the first handle to the frame to increase the force applied to the body surface through the one or more stimulating elements; and
rolling at least one of the one or more stimulating elements across the body surface at a first axis by moving at least the first handle.

16. The method of claim 15 further comprising stretching one or more additional resilient members connecting the second handle to the frame;

17. The method of claim 15 further comprising disconnecting at least one of the one or more resilient members from the frame and the first handle and connecting one or more replacement resilient members to the frame and the first handle, wherein the replacement resilient members are more or less difficult to stretch than the at least one of the one or more resilient members.

18. The method of claim 15 further comprising disconnecting a coupling edge between two rows of the frame to remove a row of the one or more stimulating elements.

19. The method of claim 15 further comprising rolling at least another of the one or more stimulating elements across the body surface at a second axis, wherein the first axis is distinct from the second axis.

20. The method of claim 15, wherein rolling the at least one of the one or more stimulating elements across the body comprises rolling the at least one of the one or more stimulating elements in an irregular manner about a non-circular opening in the at least one of the one or more stimulating elements.
